(19) United States
(12) Patent Application Publication
(10) Pub. No.: US 2023/0331464 A1
(43) Pub. Date: Oct. 19, 2023

(54) Cake Enclosure

(71) Applicant: Joan Bishop, Viera, FL (US)

(72) Inventor: Joan Bishop, Viera, FL (US)

(21) Appl. No.: 17/719,478

(22) Filed: Apr. 13, 2022

(51) Int. Cl. B65D 85/36

(52) U.S. Cl. CPC B65D 85/36

(57) ABSTRACT

An improved sanitary storage enclosure for cake and other food items is disclosed. The enclosure includes a cover defining an upper surface and a side surface unitary with the upper surface. The upper and side surfaces provide an interior region for storing cake and other food items. The improvement includes the cover being devoid of openings for enabling the interior region to be sanitary. The improvement further includes at least one elongated member having one end portion secured to the cover and an opposite end portion movable between a first position for propping open the cover so that cake and other food items can be removed from the interior region and a second position for closing the cover for maintaining a sanitary environment for the cake and other food items within the interior region.

### REFERENCE TO RELATED APPLICATION

The present US patent application is a nonprovisional patent application based upon my provisional US patent application, U.S. Ser. No. 63/220,001 filed Jul. 9, 2021, hereby incorporated by reference in its entirety for priority purposes.

### FIELD

The present subject matter, generally directed to an article of manufacture designed to protect certain food items, is more particularly directed to an article of manufacture designed to enclose and thereby prevent cake and other food items served at a variety of festive events from becoming contaminated by people there or from being contacted by, and thereby contaminated by, germs or viral particles.

### BACKGROUND

Throughout the years a familiar custom has evolved in which birthdays and similar occasions are celebrated using a symbolic cake decorated with appropriate figures and legends fashioned from pastry icing or the like. In accordance with this evolving custom, candles, often representative of the age of a birthday celebrant, are embedded in an upright position on an upper surface of the cake. Thereafter, the candles are lit, and the celebrant invited to attempt to blow the candles out, with the object of accomplishing the extinguishing of all candles in a single breath. After the celebrant has successfully blown out all candles, the candles are removed; and the cake is divided among the remaining celebrants and guests; and is eaten.

While the above-noted custom is one gayly celebrated and enthusiastically enjoyed by many birthday participants, there are certain aspects of such a custom which result in somewhat undesirable side effects. For example, many people feel uncomfortable about consuming a cake right after a birthday celebrant has blown out the candles for fear of certain unsanitary aspects, such as cake contamination.

In addition, the embedding of candles in frosting and/or decorative icing, and their subsequent removal prior to cutting and consuming cake, can result in partially ruining the ambience that the decorative icing and frosting were designed to provide. Also, the embedding of candles in icing, and their subsequent removal, frequently wastes a substantial portion of the frosting and decorative icing due to a tendency of frosting and/or icing to stick to the candles ultimately thrown away.

Moreover, after even short periods of burning, candles often drip melted wax on the surrounding cake surface which, must itself, be removed before cutting.

Due to such problems, there has arisen a need for a better approach to the celebration of occasions such as birthdays where candles are embedded within an upper surface of a decorated cake, to be later blown out by the birthday celebrant.

Relevant prior art, analyzed for a solution to these problems, resulted in my finding the following references. US 2014/0224798 to Johnson discloses a festive cake shield. The cake shield, designed to protect cake and other baked goods from airborne contaminants, has a cover portion that houses a cake, and includes a lid that fits over the cover portion. Along an upper wall of the cover portion are a great many openings. Candles and various decorative elements, inserted through these openings, are embedded into an upper surface of an underlying cake. An assertion, when birthday celebrants blow out birthday their candles, is that their exhalation is largely blocked by the cover portion and does not reach the cake surface. When the cake is no longer in use, the lid is placed over the cover portion. The lid covers the openings, to prevent dust and debris from falling on the cake while it is stored.

US 2009/0181335 to Tropeano discloses a so-called sanitary birthday cake cover-and-candle system. The disclosed system, designed for use with a birthday cake, includes a so-called “sanitary cover,” several candles, and a serving tray. The cover has a top surface and a side joined to the top surface. The cover includes a fastening lip, and has a recessed groove, for removably coupling the tray to the lip.

US 2020/0060454 to Mazzola discloses another cake covering assembly. This assembly, said to be designed to protect cake from contact by bodily fluids of people gathered around the cake, includes a cover that one can position over the cake. The cover, made of a fluid impermeable material, is said to inhibit bodily fluids from becoming found on the cake. However, the cover has several openings sized to encircle candles. Several candle holders, which Mazzola calls “cups,” are fixed to the cover. Each cup, aligned with an opening, is sized to support one of the candles.

US 2021/0369024 to Kay discloses a cake shield. The cake shield includes a top cover and a side wall dimensioned to enclose a cake. The cake shield is said to be able to prevent contamination during a celebration where many are present. The cake shield includes a top cover which includes several recesses. One such recess is for a track dimensioned to hold several candles. Another recess, cylindrical or conical in cross section, is configured for a candle with a rectangular footprint. Yet another recess, made of transparent material, allows a cake to be viewed under the shield. Said cake shield further includes a base wall supporting the side wall of said top cover. Finally, two or more so-called “pieces” interlock to form the base wall; and a kit includes a base plate for supporting both the cake and the side wall, as well as decorations for the top cover, which include candles and other materials.

US 2021/0219757 to Griffin, Jr. discloses an assortment of transparent cake holders with covers, both circular and rectangular, of assorted size and shape. The covers include recessed, form-fitting “wells,” positioned on a cover to hold birthday candles. Each cover is said to provide a germ-proof barrier between the cake and the candles whenever a birthday celebrant blows the candles out. Since the cake holder and cover are made of a durable yet relatively thin biodegradable plastic material, after the cake is finished, the cake holder and cover can both be recycled.

US 2020/0345164 to Loar, Sr. discloses a cake cover designed for protecting and for securing a cake, or another food item. The cake cover includes a washable enclosure having several receptacles, positioned on the cover, designed to receive interchangeable “inserts.” The inserts enable people to customize the appearance and function of the cake cover. The inserts are said to be useable as candle-holding inserts, light-emitting inserts, and/or so-called “sound-emitting” inserts. An outer surface of the cake cover includes decorative texturing that mimics a baked cake in appearance. The outer surface can be constructed of a transparent or translucent material for enabling a cake stored therein to be viewed through the cake cover. In addition, the cake cover further includes means for securing the cover to a surface.

My review of these US patents and US published patent applications, each one of which is hereby incorporated by reference in its entirety, has revealed that they do not individually anticipate or collectively render obvious, to one of ordinary skill in this field, the present subject matter. Throughout this patent application, my reference to the phrase “the present subject matter,” shall be a reference to a feature and/or advantage of my present invention—which I shall now summarize.

### SUMMARY

The present subject matter relates to storage enclosures for cakes, deserts, and other food items. Such food storage enclosures often have a cover consisting of an upper surface unitary with a side surface that extends from the upper surface. For such food storage enclosures, the upper surface and the side surface together define an interior space, within the cover, to store cake and other food items noted.

The present subject matter—my invention—involves features I developed to improve food storage enclosures, for ensuring that cakes and other desert and food items contained in such enclosures are provided with a sanitary environment.

One embodiment of my sanitary enclosure for storing food includes a tray on which a birthday cake is placed. Also included in this embodiment is a cover, sized and configured to fit over the cake and tray. The cover is of special design, for assuring a sanitary environment. A pair of “handstands,” used by a person to lift and support the cover high enough to enable the cake to be sliced, is also included.

The “handstands” are elongated structures I designed to support the cover when lifted. In this patent specification, I shall refer to them as “elongated support members,” a function they serve, or as “legs” or “stilts,” structural images familiar to many. Each support member has end portions that are spaced apart, so that one of the end portions is removably secured to the cover, and so the other of the end portions is used to “prop open” the cover, to enable food to be removed from the sanitary environment. In embodiments, the side surface has a lower edge margin snap-engageable with a tray on a table or countertop. In embodiments where the upper surface is unitary with several joined side surfaces, the side surfaces define the lower edge margin noted. In all embodiments of the present subject matter, the upper surface and the side surface(s) of the cover are “closed,” meaning they have no holes or cracks. In embodiments of the enclosure, designed to store food in a sanitary environment, the tray has been designed to be snap-engageable with the lower edge margin of the cover, to provide an air-tight seal, for assuring a sanitary environment after the tray is placed upon a serving table or a countertop.

The tray includes a peripheral edge portion to which the lower edge margin of the cover side surface is secured, to enable the enclosure to be used to store food items in a sanitary manner. Yet, the secured lower edge margin of the cover is easily separated from the tray, for enabling removal of any food item displayed.

Each “handstand” or “elongated support member” has a first end portion, secured to the cover, and a length sufficient to enable a portion of the lower edge of the cover side surface to be “propped up” above a serving table or countertop, when the other end portion of at least one of the support members contacts a support surface, for enabling food to be removed from the sanitary environment.

In one embodiment of my enclosure for storing food, side surfaces of the cover are defined by a spaced-apart pair of sidewalls, a front wall, and a back wall spaced from the front wall. The front and back walls are unitary with the sidewalls.

While the upper surface of the cover can be square in relation to one embodiment, the upper surface can be rectangular for other embodiments. For rectangular embodiments, the length of the sidewalls can range from about 35% to about 85% of the length of the front and back walls. Embodiments can include various numbers of candle holders. Each holder is secured to, yet removable from, a portion of the exterior upper surface of the cover. In addition, each candle holder is made of an elastomeric material sufficiently deformable, that an end portion of a candle can be inserted into an aperture defined by the elastomeric material. Yet, the elastomeric material is sufficiently rigid that the candle in the aperture extends substantially perpendicular to a plane defined by the upper surface of the cover.

### BRIEF DESCRIPTION OF THE DRAWING FIGURES

FIGS. 1, 2 are perspective views of a prior art enclosure, with FIG. 1 showing celebratory items on a cake and with FIG. 2 showing the items and cake separated.

FIG. 3 is an upper surface of one embodiment of the present subject matter.

FIG. 4 is a perspective of another embodiment of the present subject matter.

FIG. 5 is another perspective view of the embodiment illustrated in FIG. 4.

FIG. 6 illustrates a component of the embodiment shown in FIGS. 4 and 5.

FIGS. 7A, 7B are perspective views, on an enlarged scale relative to FIG. 4, of a candle holder where (FIG. 7A) is “with” a candle and (FIG. 7B) is “without,” showing a FIG. 4 component of this embodiment of the present subject matter.

FIG. 8 is a perspective of another embodiment of the present subject matter.

FIG. 9 is another embodiment of a component of the present subject matter, with other embodiments of this component being illustrated in FIGS. 4, 5, and 8.

FIG. 10 is a partially-fragmented side elevational view, on an enlarged scale relative to FIGS. 4, 5, 8 and 9, of a component of the present subject matter, usable in any embodiment of the present subject matter covered by the appended claims.

Throughout the drawing figures and detailed description, I shall use similar reference numerals to refer to similar components of the present subject matter.

### DETAILED DESCRIPTION

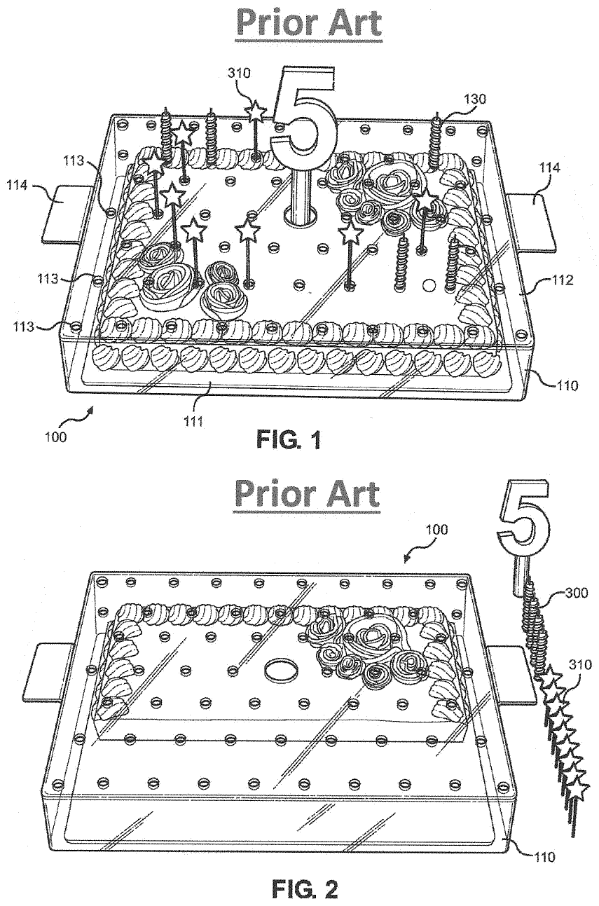

Before describing the present subject matter—my invention—I shall briefly compare the prior art to my improved enclosure for cake and other food items, and contrast features of the present subject matter to deficiencies noted in the prior art. FIG. 1 of US published patent application 2014/0224798 to Johnson shows an overhead perspective view of a cake shield, with candles and decorations in place. FIG. 2 is the cake shield of FIG. 1, without the candles and decorations.

In FIGS. 1 and 2, a prior art cake shield 100, having a cover 110, is shown.

A birthday cake, underneath cover 110, is shown enclosed by sidewalls 111 and an upper surface (where “upper surface” is to be read as wall 112) of the cover 110. Optional handles 114 may extend outwardly from an upper portion of the cover 110. Several apertures—which I shall refer to as “openings” 113 hereafter throughout this patent specification—extend through the upper surface (wall 112). The openings are configured to accommodate different sized birthday candles 300.

A number of candles 300 (five are inserted) and other decorative elements 310 are inserted through associated openings 113 and into the underlying cake. Uppermost portions of the candles 300 and other decorative elements 310 are exposed, above the upper wall 112, to provide a user access to the candlewicks.

As noted, there has arisen a need for a more sanitary, better approach to enable people to invite friends and family members to celebratory occasions including but not limited to Weddings, Bar and Bat Mitzvahs, Birthday Parties, and other celebrations where families gather to celebrate special events and eat food.

Yet, celebratory cakes and other foods are not only subject to potential contamination by caterpillars, flies, and other insects, these food items are also subject to potential contamination from air-borne nuisances including but not limited to dust, dirt, germs, viral particles, and plant-based particles such as pollen.

As mentioned, the celebratory cakes at such gatherings are susceptible to contamination from germs exhaled by persons blowing out candles on such cakes. While a few people have resorted to waving a hand, or both hands, to extinguish one or more candles, such a procedure is not only cumbersome but also ineffective.

While contemplating ways of overcoming unsanitary conditions noted in the prior art, I conceived and developed embodiments of the present subject matter.

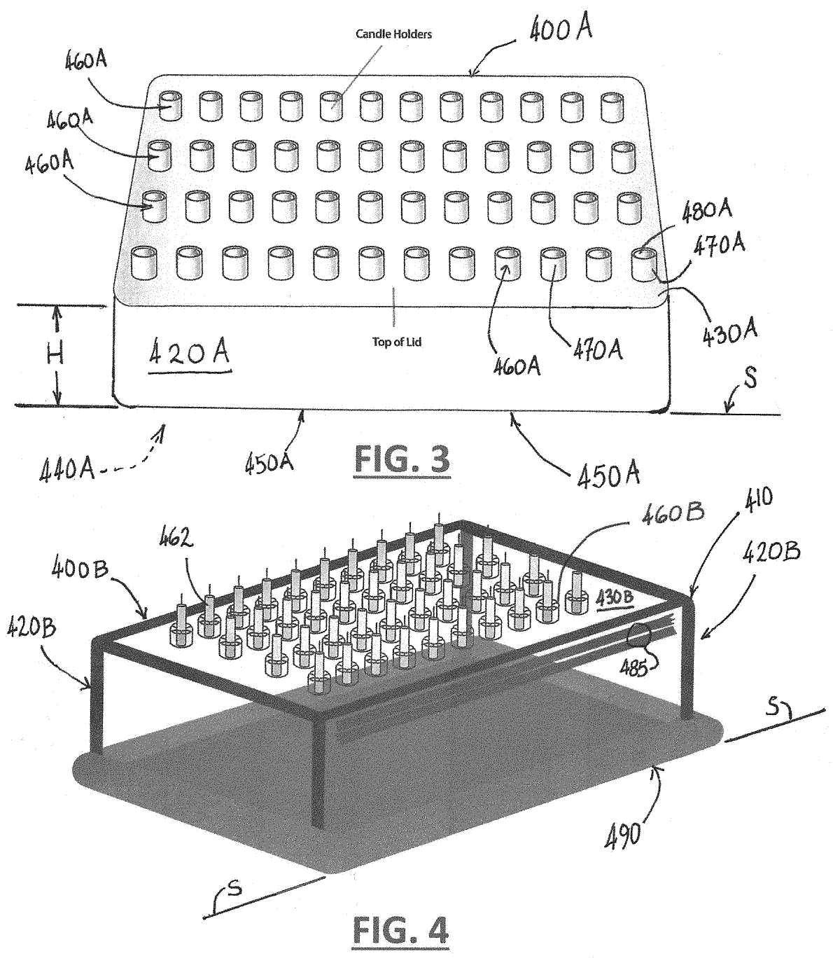

FIG. 3, an early embodiment of the present subject matter, depicts a cake covering lid. At that time, I also thought about and conceived a word (or trademark) which I intend to use to market the various embodiments of the present invention which I shall describe in detail further below. That word (or trademark) is “LIDDIES” which I selected to enable the public to associate a line of products that I intend to market under the protection of the claims that are granted when this patent issues.

My intended trademark LIDDIES™ sprung from my FIG. 3, which shows an early embodiment of an aperture-free and crack-free lid 400A having a unitary base 420A. I designed the lid 400A, not only to “cover” birthday or other cakes and an assortment of festive food items, but also to provide a sanitary and germ-free environment. The illustrated lid 400A includes an exterior upper surface 430A and an interior underside surface 440A (not visible) opposite the upper surface 430A.

The underside surface 440A is, of course, spaced above an upper surface of such cake(s) and other festive desert or food items (not shown), which are to be covered by the lid 400A. In this embodiment, the base 420A of the lid 400A includes a lower lip or edge margin 450A that is substantially flat, for providing a sanitary environment for cake and other festive desert and food items that could be stacked upon a platter (not shown) placed on a flat surface S (such as a table or countertop).

A height H value for the base 420A, based upon a measurement extending from the underside surface 440A to the top of the various food items stacked upon the platter will (of course) vary, and will (of course) depend upon a measured elevational value required to maintain the sanitary environment (outlined above), for various cakes and other festive desert and food items stacked upon the platter.

My marketing plan, therefore, is to provide the public with an assortment of lids 400A, having height H values ranging from about 4 inches to about 18 inches.

Also depicted in FIG. 3 are forty-eight candle holders 460A, which I show arranged in four horizontal rows and twelve vertical columns, and with each candle holder 460A having a cylindrical sidewall 470A and a closed-bottom recess 480A.

Each closed recess 480A has a preselected diameter, for snuggly retaining, substantially vertically in each recess 480A, one of the candles (not shown). The plural candle holders 460A are fixed to the upper surface 430A. However, because birthday and other cake-mounted candles are sold in many diameter sizes, and because most consumers will want to “customize” embodiments of the present subject matter, “fixed” candle holders 460A are removable, for enabling consumers to fashion embodiments of the present subject matter to achieve a desired effect.

For instance, because I designed the candle holders 460A to be removable, other (removable) candle holders can be “fixed” to the upper surface 430A, for enabling consumers to select a desired number of candle holders, sized to accommodate diameters of various commercially available candles. For these and other reasons, I selected LIDDIES™ as my brand to market such a variety of lids.

In FIG. 3, the upper surface 430A of lid 400A is substantially rectangular, while base 420A defines walls that are substantially vertically oriented relative to surface S. Unlike the prior art lid (or cover), shown in FIGS. 1 and 2, with holes or apertures that do not provide a sanitary environment, my lids 400A, of one-piece construction and devoid of holes and cracks, are especially designed to provide a sanitary environment to cake and all other desert and food items which they cover.

Moreover, because all lids (or covers), which I plan to market under my LIDDIES™ brand, shall function as sanitary storage enclosures for cake and/or other food items, I shall refer to them throughout this patent specification as components of the sanitary food-storage enclosure of the present subject matter. See, e.g., FIGS. 4-6 for another embodiment, in accordance with the present subject matter, of a sanitary enclosure 4008 for storing cake and other food items.

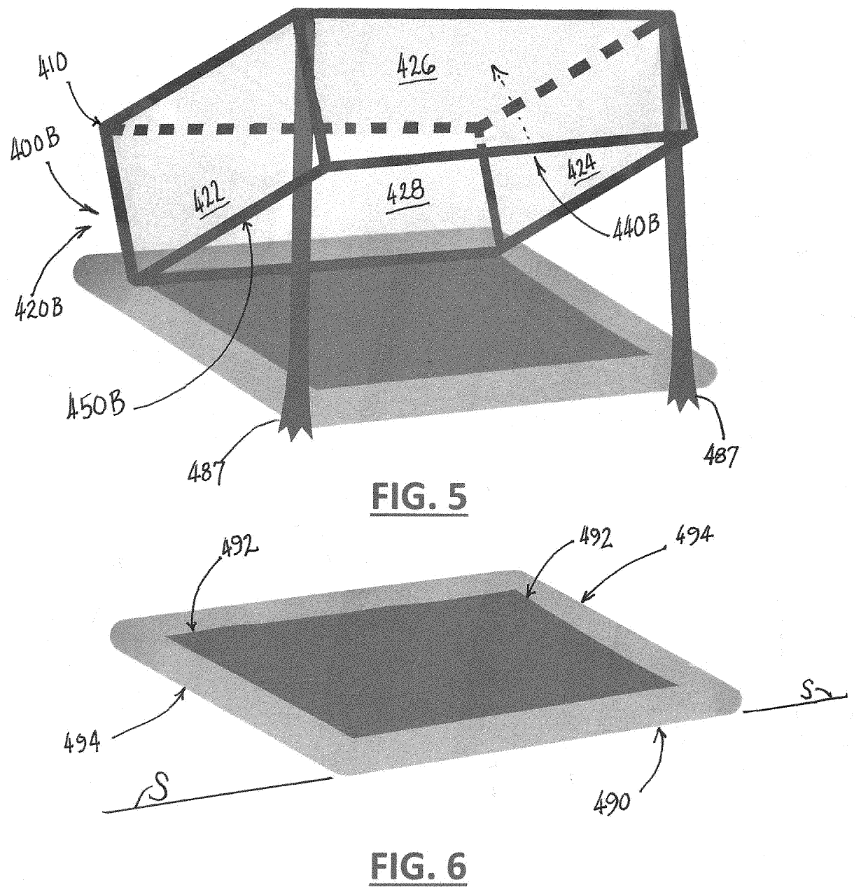

The illustrated enclosure 400B of the present subject includes a one-piece, aperture-free, crack-free rectangular cover 410. The cover 410 consists of a unitary base (or side surface) 420B, an exterior upper surface 430B (FIG. 4), and an interior underside surface 440B (referenced by a semi-dotted line in FIG. 5). The base or side surface 420B consists of spaced-apart side surfaces 422, 424; front surface 426; and back surface 428, all of which are rectangular as shown in FIG. 5.

In addition to the rectangular-shaped cover 410 illustrated by FIGS. 4-6, the present subject matter is applicable to square-shaped covers (not shown) and an assortment of other cover shapes, so long as the novel, patentable features of the present subject matter are present. For instance, circular-shaped cylindrical covers disclosed in US published patent applications 2009/0181335 to Tropeano and 2020/0060454 to Mazzola would be within the scope of the present subject matter if the novel, patentable features of the present subject matter are present.

Also, cover sidewalls need not be cylindrical, as shown in US 2009/0181335 and US 2020/0060454. Indeed, if a circular cover were to include the patentable features described in this patent specification, such a circular cover would be within the scope of one or more of the appended claims. Further in this regard, a cover sidewall could be described by other geometric shapes, including a “frustoconical” shape (as certain figures of U.S. Pat. No. 5,501,358 to Hobday; U.S. Pat. No. 5,423,536 to Brown; and U.S. Pat. No. 5,307,039 to Chari et al. enable one of ordinary skill in this field, viewing certain figures of these patents, to envision), if patentable features of the present subject matter are present. Those of ordinary skill in this field can also appreciate that covers having elliptical or various polygonal shapes, including 3-sided, 5-sided, and 7-sided upper surfaces, would all be within the scope of one or more of the appended claims, if the patentable features of the present subject matter are present. All such covers are within my LIDDIES™ sales/marketing plan.

To summarize, while the side surfaces 422 and 424, the front surface 426, and the back surface 428 (FIG. 5)—each unitary with upper surface 430B (FIG. 4)—are arranged along the perimeter of the upper surface 430B, each of these surfaces (422, 424, 426, and 428) is oriented substantially at a right angle with respect to the upper surface 430B. One of ordinary skill in the field of providing a sanitary environment, for celebratory cake, festive desserts, fresh fruit, another other food items, can appreciate that a cover having side surfaces that are trapezoidal in shape—and which extend downwardly from the upper surface to provide a footprint that is larger in area than the upper surface—would also be within the scope of my invention, if patentable features of the present subject matter are also present.

The upper surface 430B (FIG. 4) is unitary with the base 420B. The base 420B includes side surfaces 422 and 424, front surface 426, and back surface 428. The upper surface 430B and the base 420B together define an interior region or space within cover 410, for storing cake and other food items in a sanitary environment.

The enclosure 400B shown in FIG. 4 includes forty candle holders 460B, arranged rectangularly in four horizontal rows and ten vertical columns. Each candle holder 460B is fixed to the cover 410 along its upper surface 4308 by a removable adhesive material selected from commercially available wood glues, elastomers, silicone sealants, and pressure sensitive tapes and films. Each candle holder 460B shown in FIG. 4 contains a wicked candle 462. Candle holders 460B shown in FIG. 4 were removed from the cover 410 shown in FIG. 5, and the width of cover 410 shown in FIG. 5 reduced, relative to the cover width shown in FIG. 4, to better illustrate features and advantages of the present subject matter.

The cover 410 (FIG. 5) of the present subject matter includes a lower lip or edge margin 4508 that is not only unitary with the cover 410, but also substantially flat, for enabling the lower edge margin 450B of the enclosure 400B (FIGS. 4, 5) to be placed on a substantially flat surface S (FIG. 4), to thereby provide a sanitary environment for cake and/or other food items contained within the interior space. Also, this embodiment of the enclosure 400B of the present subject matter includes a pair of “handstands” (as the FIG. 5 embodiment visualizes), which I have since changed to legs, stilts, or elongated support members for reasons noted above. The legs or stilts 485 (shown in FIG. 4) are fastened with plastic screws (not shown), so that they can swing outwardly and downwardly from cover 410 when the lower edge of the front surface 426 (FIG. 5) is lifted above the surface S noted (FIG. 4).

Further in this regard, yet another embodiment of the elongated support members 487 of the present subject matter (FIG. 5) provides each support member 487 with an end portion that can be positioned within an inner corner portion of the cover 410 at opposite ends of the front surface 426 to hold up and brace the front surface 426 of the cover 410 above surface S (FIG. 4), for enabling food to be selected and removed from the sanitary space that cover 410 provides.

Additional embodiments of the elongated support members of the present subject matter include certain features (that I will describe in detail further below), enabling them to be removably mounted within an inner surface of the base 420B.

This embodiment of the enclosure 400B of the present subject matter also includes a tray 490 (FIG. 6) having peripheral edge margins 492 dimensioned and configured to provide an air-tight seal along the entire lower edge margin 4508 (FIG. 5), when joined to the unitary base 420A of cover 410 as shown in FIG. 4.

Such a tray 490 can be placed upon a support surface S, which includes but is not limited to an upper surface of a table and a countertop. For reasons noted above, I designed the tray 490 to include a unitary cushion 494 surrounding the peripheral edge margins 492. The cushion 494 can be—and preferably is—configured, dimensioned, and made of a suitable polymeric material, that is effective for frictionally engaging the lower edge margins of the base 4208, for snugly retaining the lower edge margin 450B in contact with the peripheral edge margins 492 of the tray 490, to provide and maintain the air-tight seal noted above.

Accordingly, in accordance with the present subject matter, suitable polymeric material for this purpose can include and is not limited to unsaturated and saturated rubbers. Suitable unsaturated rubbers can include natural isoprene; synthetic isoprene; polybutadiene; chloroprene; butyl rubber; styrene-butadiene rubber; and nitrile rubber. Suitable saturated rubbers include polyacrylic rubber; ethylene-propylene rubber; epichlorohydrin; silicone and fluorosilicone rubber; polyether block amides; chlorosulfonated polyether; and ethylene-vinyl acetate.

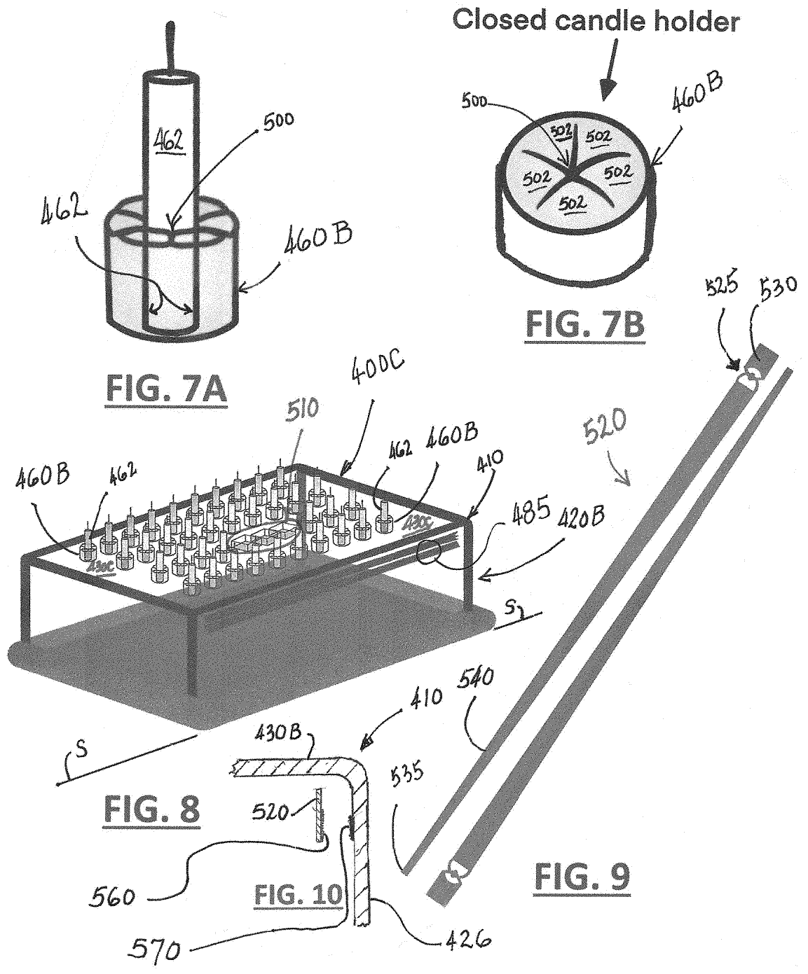

FIGS. 7A and 7B present enlarged, detailed views of candle holders 460B shown in FIG. 4. Each candle holder 460B is made of an elastomeric material, sufficiently deformable for inserting an end portion of an associated candle 462 into an aperture 500 (FIGS. 7A, 7B) formed within the elastomeric material, yet sufficiently rigid for enabling the candle 462, after insertion of its end portion into the aperture 500, to extend from holder 460B substantially perpendicular to the exterior upper surface 430B of the cover 410 of the enclosure 400B (FIGS. 4, 5). Suitable elastomeric materials suitable for purposes of the present subject matter include but are not limited to the unsaturated and saturated rubbers recited above.

In accordance with an additional feature of the present subject matter, a thin layer of a commercially available removable adhesive material, applied to an underside surface of individual candle holders 460B (FIG. 7A), can be used to secure a preselected number of the candle holders 460B to the exterior upper surface 430B (FIG. 4) of a cover 410 having none (FIG. 5). Commercial examples of adhesive materials suitable for formulating such an adhesive layer include wood glues, elastomers, silicone sealants, and various pressure sensitive tapes and films.

A well or aperture 500, formed substantially vertically along a central axis, is provided by several, for example, five radially-extending and inwardly-oriented integral “fingers” 502 formed unitarily with an individual candle holder 460B (FIG. 7B). Candle holders 460B of the present subject matter can be made of an elastomeric material, sufficiently deformable that an end portion of a preselected candle can be inserted into a well or aperture 500 (FIG. 7A), yet, also sufficiently rigid that a candle inserted into the well 500 extends substantially perpendicular to a plane defined by upper surface 430B of cover 410 (FIG. 4). In addition, the unsaturated and saturated rubbers recited above can frictionally engage a candle 462 in its well 500, to assure it is held substantially perpendicular as shown (FIG. 4).

Another embodiment of the enclosure 400C of the present subject matter is shown in FIG. 8. While the distribution and arrangement of the candles 462 about the upper surface 430C of this embodiment of the enclosure 400C appears to resemble the candle arrangement shown in FIG. 4, one notable difference, in the region identified by the reference numeral 510, is that three square-shaped receptacles have been substituted for three of the candle holders 460B. (Reference numeral 510 is located approximately centrally on the outer upper surface 430C.)

One or more receptacles within the region identified by reference numeral 510 could be sized and configured to receive a candle having a horizontally oriented square cross section (visibly greater than candle 462), selected for a special event. For instance, to celebrate the birthday of a parent, three such candles, each having a base sized to fit into the square-shaped receptacles, with three of such “candles” presenting a letter, having a height ranging from about twice to about three times the height of a candle 462, could be letters chosen to spell the word “MOM” or “DAD” with as many wicked candles 462 lit, as needed, to celebrate that birthday.

Pursuant to the present subject matter, an embodiment of yet another matched pair of elongated support members 520, called “handstands,” “legs,” and “stilts” above, is illustrated by FIG. 9. However, unlike the “handstand” versions, identified by the reference numeral 485 in FIGS. 4 and 8 and by the reference numeral 487 in FIG. 5, this embodiment of a matched pair of elongated support members 520 has a hinged joint 525 at one end portion 530 and includes an opposite end portion 535, which is used to support the cover 410. In addition, this embodiment of the support members 520 of the present subject matter are made of a commercial material that does not flex, when used to support the cover 410 for reasons noted above. Each support member 520 includes an elongated section 540, connected by hinged joint 525 to the end portion 530, as shown in FIG. 9.

Moreover, all elongated support members of the present subject matter, including (and not limited to) the support members 485 shown in FIGS. 4 and 8; the support members 487 shown in FIG. 5; and the support members 520 shown in FIG. 9, are relatively thin, as shown in the partially fragmented side elevational view of FIG. 10. For instance, the thickness of a support member 520 is typically less than a wall thickness of upper section 4308 and front section 426 of cover 410.

Another method for securing the elongated support member 520 to the cover 410 involves using a product sold under the registered trademark “VELCRO” which is not only the name of a company but also often used by consumers to refer to the product itself. Such “use” is, of course, incorrect for the reason that a trademark is only to be used as an adjective, by referring to the brand under which the product is sold, and is never to be used as a noun to refer to the product itself.

In particular, as background, first the company, then the product: VELCRO, officially known as Velcro IP Holdings LLC and trading as Velcro Companies, is a British privately held company, founded by Swiss electrical engineer George de Mestral in the 1950s. It is the original manufacturer of hook-and-loop fasteners, which de Mestral invented. Currently, hook-and-loop fasteners are well known. See, for example, U.S. Pat. No. 4,447,060 to Guinn; U.S. Pat. No. 4,488,323 to Colburn; and U.S. Pat. No. 4,498,615 to Johnson. Assorted Velcro® brand products, including strips of hook-and-loop fasteners, are available online at www.textol.com/velcro

To secure the elongated support members 520 shown in FIG. 9 to the cover 410 shown, for example, in FIGS. 4 and 8, thin strips of hook-and-loop fasteners can be used. In particular, a thin strip of hooked material 560 can be secured to a side surface of one of the elongated support members 520, at the end 530 adjacent hinged joint 525 as well as along the length of elongated section 540. Also, a thin strip of looped material 570 can be secured to an interior surface of front section 426 at the interior corner adjacent an interior surface of upper section 430A of the cover 410, as shown in FIG. 10. One of ordinary skill can appreciate that swapping the hook-and-loop material strips secured to one of the structures described above to the other structure described will provide an equivalent result.

Moreover, as one of ordinary skill in this field can appreciate, only one support structure 520 (FIG. 9) may be needed, and therefore can be used, to support cover 430B (FIG. 4) or cover 430C (FIG. 8), for raising the cover to select, e.g., a piece of cake. To enable using only one support structure 520, the end portion 530 adjacent the hinged joint 525 is secured to either an interior surface or an exterior surface of the cover. Also, those of ordinary skill in this field can appreciate that covers having certain polygonal shapes, e.g., 3-sided, 5-sided, and 7-sided upper surfaces, would all be within the scope of one or more of the appended claims, if patentable features of the present subject matter are present.

Various thin strips of hook-and-loop material can be secured, preferably permanently, to structure, including but not limited to the structure described above, by several commercially available adhesives, some of which are commonly referred as glue, cement, mucilage, or paste, if such adhesives when applied to one or both surfaces that are to be joined together, binds these surfaces together and resists their separation. Suitable permanent adhesives, for purposes of the present subject matter include but are not limited to natural rubber and polychloroprene.

What has been illustrated and described in this application is an improved enclosure for storing food in a sanitary environment. While the present subject matter has been described in reference to several embodiments of my novel food enclosure including a wide assortment of features, the present subject matter is not limited to these embodiments. On the contrary, many alternatives, changes, and/or modifications will become apparent to those of ordinary skill in the field of the present subject matter after this application has been read. Therefore, all such alternatives, changes, and modifications are to be viewed as part of the present subject matter insofar as they fall within the spirit and scope of the following claims.

I claim:

1. An improved sanitary storage enclosure for cake or other food items comprising:
a cover defining:
an upper surface and
a side surface unitary with and disposed transverse to the upper surface,
wherein the upper surface and the side surface together define an interior space within the cover for storing cake or other food items, and
wherein the cover is mountable upon a support surface,
wherein the improvement comprises:
at least one support member having spaced apart end portions,
wherein one of the end portions is removably secured to the cover,
wherein the upper and side surfaces of the cover are devoid of openings,
wherein the side surface has a lower edge contacting the support surface,
wherein the support member has a length sufficient to cause a portion of the lower edge to be spaced above the support surface when the other end portion of the support member contacts the support surface, for enabling a person to access the cake or other food items in the sanitary enclosure.

2. The improved sanitary storage enclosure of claim 1, wherein the side surface consists of:
a spaced-apart pair of sidewalls and
a spaced-apart pair of front and back walls unitary with the sidewalls.

3. The improved sanitary storage enclosure of claim 2, wherein the upper surface is rectangular.

4. The improved sanitary storage enclosure of claim 1, further including:
at least one candle holder removably secured to an exterior portion of the cover upper surface,
wherein the at least one candle holder comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.

5. The improved sanitary storage enclosure of claim 1, further including:
a plurality of candle holders, wherein each one of the plurality of holders is removably secured to an exterior portion of the cover upper surface, and
wherein each one of the plurality of candle holders comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.

6. An improved sanitary storage enclosure for cake or other food items comprising:
a cover defining:
an upper surface and
a side surface unitary with and disposed transverse to the upper surface,
wherein the upper surface and the side surface together define an interior space within the cover for storing cake or other food items,
wherein the cover is mountable upon a support surface,
wherein the improvement comprises:
at least two support members,
wherein each support member has spaced apart end portions,
wherein one of the end portions of each of the at least two support members is removably secured to the cover,
wherein the upper and side surfaces of the cover are devoid of openings,
wherein the side surface has a lower edge contacting the support surface,
wherein each support member has a length sufficient to cause a portion of the lower edge of the side surface to be spaced above the support surface when the other end portion of at least one of the two support members contacts the support surface, for enabling a person to access the cake or other food items in the sanitary enclosure.

7. The improved sanitary storage enclosure of claim 6, wherein the side surface consists of:
a spaced-apart pair of sidewalls and
a spaced-apart pair of front and back walls unitary with the sidewalls.

8. The improved sanitary storage enclosure of claim 7, wherein the upper surface is rectangular.

9. The improved sanitary storage enclosure of claim 6, further including:
at least one candle holder removably secured to an exterior portion of the cover upper surface,
wherein the at least one candle holder comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.

10. The improved sanitary storage enclosure of claim 6, further including:
a plurality of candle holders, wherein each one of the plurality of holders is removably secured to an exterior portion of the cover upper surface, and
wherein each one of the plurality of candle holders comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.

11. An improved sanitary storage enclosure for cake or other food items comprising:
a cover defining:
an upper surface and
a side surface unitary with and disposed transverse to the upper surface,
wherein the upper surface and the side surface together define an interior space within the cover for storing cake or other food items,
wherein the improvement comprises:
at least two support members,
wherein each support member has spaced apart end portions,
wherein one of the end portions of each of the at least two support members is removably secured to the cover,
wherein the upper and side surfaces of the cover are devoid of openings,
wherein the side surface defines a lower edge portion; and
a tray disposed upon a support surface,
wherein the tray defines a peripheral edge portion to which the lower edge portion of the side surface of the cover is removably securable,
wherein each support member has a length sufficient to cause a portion of the lower edge of the side surface to be spaced above the support surface when the other end portion of at least one of the two support members contacts the tray or the support surface, to enable a person to access the cake or other food items in the sanitary enclosure.

12. The improved sanitary storage enclosure of claim 11, wherein the side surface consists of:
a spaced-apart pair of sidewalls and
a spaced-apart pair of front and back walls unitary with the sidewalls.

13. The improved sanitary storage enclosure of claim 12, wherein the upper surface is rectangular.

14. The improved sanitary storage enclosure of claim 11, further including:
at least one candle holder removably secured to an exterior portion of the cover upper surface,
wherein the at least one candle holder comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.

15. The improved sanitary storage enclosure of claim 11, further including:
a plurality of candle holders, wherein each one of the plurality of holders is removably secured to an exterior portion of the cover upper surface, and
wherein each one of the plurality of candle holders comprises an elastomeric material defining an aperture:
sufficiently deformable for enabling an end portion of a candle to be inserted into the aperture,
yet sufficiently rigid for enabling the candle, after insertion of the end portion into the aperture, to extend from the holder substantially perpendicular to the exterior portion of the cover upper surface.
